(19) United States
(12) Patent Application Publication
(10) Pub. No.: US 2012/0121323 A1
(43) Pub. Date: May 17, 2012

(54) QUICK-ATTACH ASSEMBLY FOR ATTACHING AN IMPLEMENT TO AN OFF-ROAD VEHICLE

(76) Inventor: CURT J. HILL, Warba, MN (US)

(21) Appl. No.: 13/289,056

(22) Filed: Nov. 4, 2011

Related U.S. Application Data
(63) Continuation-in-part of application No. 13/135,042, filed on Jun. 23, 2011.
Application No. 13/135,042 is a continuation-in-part of application No. 12/927,346, filed on Nov. 12, 2010.

(51) Int. Cl. F16D 1/10

(52) U.S. Cl. 403/321

(57) ABSTRACT

A quick-attach assembly for selectively connecting an implement to the forward end of an off-road vehicle push tube assembly. A rear male quick-attach assembly is secured to the forward end of the push tube assembly and a front female quick-attach assembly is secured to the implement. The front and rear quick-attach assemblies may be interconnected and secured together by a locking pin.

### CROSS-REFERENCE TO RELATED APPLICATION

This application is a continuation-in-part of application Ser. No. 13/135,042 filed on Jun. 23, 2011, entitled A QUICK-ATTACH ASSEMBLY FOR ATTACHING AN IMPLEMENT TO AN OFF-ROAD VEHICLE which is a continuation-in-part of Ser. No. 12/927,346, filed on Nov. 12, 2010, entitled METHOD AND MEANS FOR CONVERTING A BLADE ATTACHMENT OF AN OFF-ROAD VEHICLE TO A QUICK-ATTACH BLADE.

### BACKGROUND OF THE INVENTION

1. Field of the Invention

This invention relates to a quick-attach assembly for attaching an implement such as a plow blade to an off-road vehicle such as an ATV, UTV, riding mower or a garden tractor.

2. Description of the Related Art

In recent years, it has become common to mount a plow blade or other implement on the forward end of an off-road vehicle such as an ATV, UTV, riding mower or garden tractor. Most manufacturers utilize a push tube assembly to mount the plow blade or implement to the vehicle. In most prior art plow blades, the rearward ends of the push tube assembly are pivoted to the vehicle about a transverse horizontal axis to permit the forward end of the push tube assembly, and the plow blade secured thereto, to be raised and lowered. In some cases, the rearward ends of the push tubes of the push tube assembly are quickly attachable to the vehicle. Generally speaking, in most prior art plow blade attachment devices, a flat base plate is secured to the forward ends of the push tubes with a blade pivot or blade swivel assembly being horizontally pivotally mounted, about a vertical axis, to the base plate so that the angle of the blade may be selectively changed. The plow blade is hingedly secured to the blade pivot assembly so that the pitch of the plow blade may be changed and so that the upper end of the plow blade may pivot forwardly with respect to the blade pivot and so that the lower end of the plow blade may pivot rearwardly should the lower end of the plow blade strike an obstruction.

Although the blade or implement attachments of the prior art perform satisfactorily, to the best of Applicant's knowledge, the plow blades or implements thereof are not quickly removably secured to the forward end of the push tube assembly. Thus, although the entire plow blade and its attachment structure may be fairly quickly attached to the vehicle, the push tube assembly cannot be used for any other purpose. Therefore, if other implements are to be mounted on the forward end of the vehicle, each of those implements must have a push tube assembly designed for the particular vehicle to which the implement is to be attached.

The invention of Applicant's co-pending application Ser. No. 12/927,346, solved most, if not all, problems of the prior art. However, in Applicant's earlier invention, disclosed in Ser. No. 12/927,346, the forwardly extending tubes of the rear adapter assembly must be fairly precisely positioned or aligned with respect to the rearwardly extending receiver tubes of the front adapter assembly to enable the forwardly extending tubes to be received in the rearwardly extending receiver tubes.

The invention disclosed in the co-pending application, Ser. No. 13/135,042, represented an improvement over the invention disclosed in the co-pending application Ser. No. 12/927,346. The instant invention represents a further improvement in the quick-attach art.

Many skid-steer vehicles have utilized quick-attach assemblies to enable the forward ends of the boom arms of the skid-steer vehicles to be quickly connected to an implement such as a bucket, blade, etc. The rear male quick-attach member is pivotally attached to the forward ends of the boom arms of the skid-steer vehicle and are pivoted by one or more hydraulic cylinders extending between the boom arms and the rear male, quick-attach member. Off-road vehicles such as ATVs, UTVs, riding lawn mowers, or garden tractors do not have hydraulic cylinders so the forward ends of the push tube assembly is simply raised and lowered by a winch or screw actuator. Thus, any quick-attach member attached to the forward end of the push tube assembly can only be raised or lowered with very little pivotal movement which presents a problem in providing a quick-attach means for off-road vehicles.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A quick-attach assembly is provided for attaching an implement to an off-road vehicle such an ATV, UTV, lawn mower or garden tractor. The off-road vehicle includes a push tube assembly having rearward and forward ends. The rearward end of the push tube assembly is secured to the off-road vehicle so that the forward end of the push tube assembly is positioned at the forward end of the vehicle. The quick-attach assembly of this invention includes a rear male quick-attach assembly and a front female quick-attach assembly. The rear male quick-attach assembly, has a forward end and a rearward end and is secured to the forward end of the push tube assembly. The front female quick-attach assembly has a forward end and a rearward end. The front female quick-attach assembly is adapted to have an implement secured thereto such as a blade, sweeper, trash container shuttle, etc. The rear male and front female quick-attach assemblies are adapted to be secured together. Preferably, the rear male quick-attach assembly is selectively removably secured to the push tube assembly. Preferably, the front female quick-attach assembly is selectively removably secured to the implement.

The rear male quick-attach assembly includes an upstanding front wall having an upper end, a lower end, a first side, a second side, a front side and a rear side. The front wall of the rear male quick-attach assembly has first and second horizontally spaced-apart ears which extend upwardly from the upper end thereof. The vehicle includes a winch or the like which is operatively connected to the rear male quick-attach assembly for raising and lowering the same.

The front female quick-attach assembly includes an upstanding front wall having an upper end, a lower end, a first side, a second side, a front side and a rear side. The front female quick-attach assembly includes a top wall having a front end, a rear end, a first side and a second side. An upstanding first side wall extends rearwardly from the first side of the front wall of the front female quick-attach assembly. An upstanding second side wall extends rearwardly from the second side of the front wall of the front female quick-attach assembly. The front female quick-attach assembly also includes a top wall having a front end, a rear end, a first end and a second end with the top wall being secured at its front end to the upper end of the front wall of the front female quick-attach assembly and which extends rearwardly therefrom. The top wall is secured to the upper ends of the first and second side walls of the front female quick-attach assembly and extends therebetween. The top wall has first and second slotted openings formed therein adjacent the front end thereof which are adapted to receive the first and second ears of the rear male quick-attach assembly therein when the rear male and front female quick-attach assemblies are secured together.

The distance between the first and second side walls of the front female quick-attach assembly is greater than the distance between the first and second sides of the front wall of the rear male quick-attach assembly so that the front wall of the rear male quick-attach assembly may pass forwardly between the first and second side walls of the front female quick-attach assembly to enable the front wall of the rear male quick-attach assembly to be positioned adjacent the front wall of the front female quick-attach assembly.

The distance between the lower end of the front wall of the rear male quick-attach assembly and the upper ends of the first and second ears is less than the distance between the lower ends of the first and second side walls and the rear end of the top wall of the front female quick-attach assembly to enable the rear male quick-attach assembly to move forwardly into the front female quick-attach assembly in a substantially horizontal manner. At least one locking device and preferably two locking devices are provided for interconnecting the front female and rear male quick-attach assemblies together.

It is therefore a principal object of the invention to provide a quick-attach assembly for attaching an implement to an off-road vehicle.

A further object of the invention is to provide a quick-attach assembly for an off-road vehicle which includes a rear male quick-attach assembly selectively removably secured to the forward end of a push tube assembly and a front female quick-attach assembly which is selectively removably attached to an implement with the quick-attach assemblies being designed to quickly and easily connect the rear quick-attach assembly to the front quick-attach assembly.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view illustrating the quick-attach assembly of this invention being used to interconnect a push tube assembly to an implement such as a blade;

FIG. 2 is a perspective view illustrating the front female quick-attach assembly of the quick-attach assembly of this invention secured to an implement such as a blade;

FIG. 3 is a perspective view illustrating the rear male quick-attach assembly of the quick-attach assembly of this invention;

FIG. 4 is a side elevational view illustrating the manner in which the rear male quick-attach assembly is moved towards the front female quick-attach assembly during the connection thereof; and

FIG. 5 is a side elevational view similar to FIG. 4 except that the rear and front quick-attach assemblies have been secured together.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The disclosure of the co-pending applications are incorporated herein by reference to complete the disclosure of the instant invention if required.

In the drawings of co-pending application Ser. No. 12/927,346, a conventional off-road vehicle such as an ATV is illustrated. The invention of the instant invention may also be used on a UTV, a small tractor or riding lawn mower.

The quick-attach assembly of this invention is referred to by the reference numeral 8 and includes a rear male quick-attach assembly and a front female quick-attach assembly as will be described hereinafter.

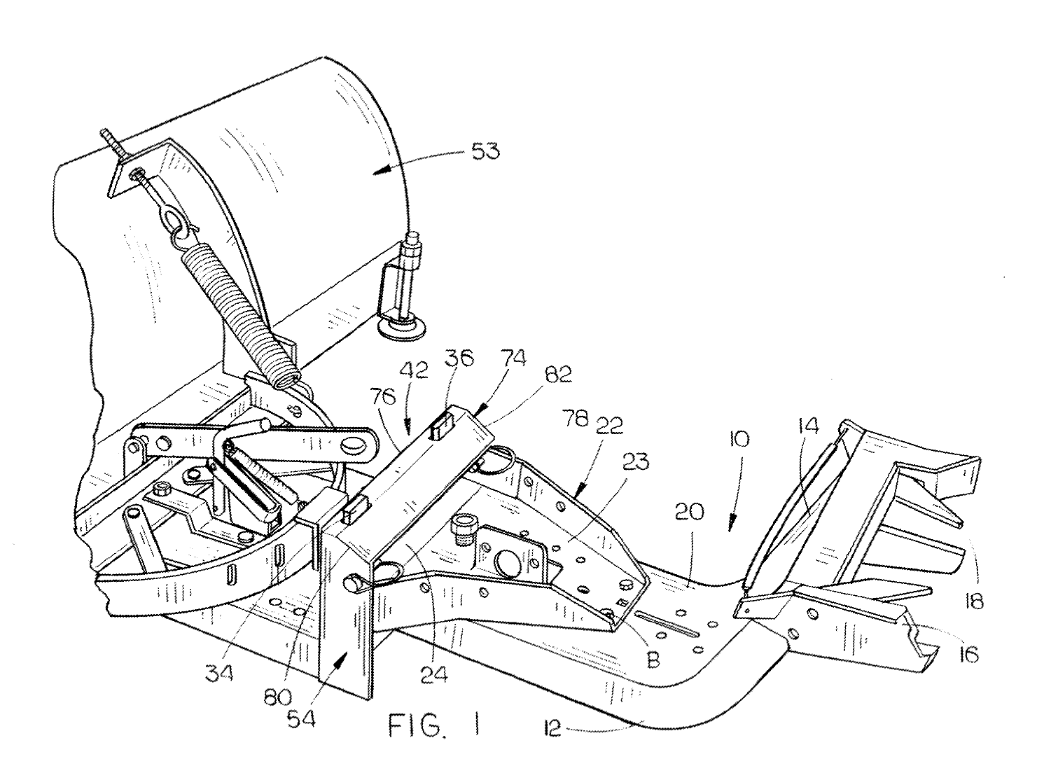

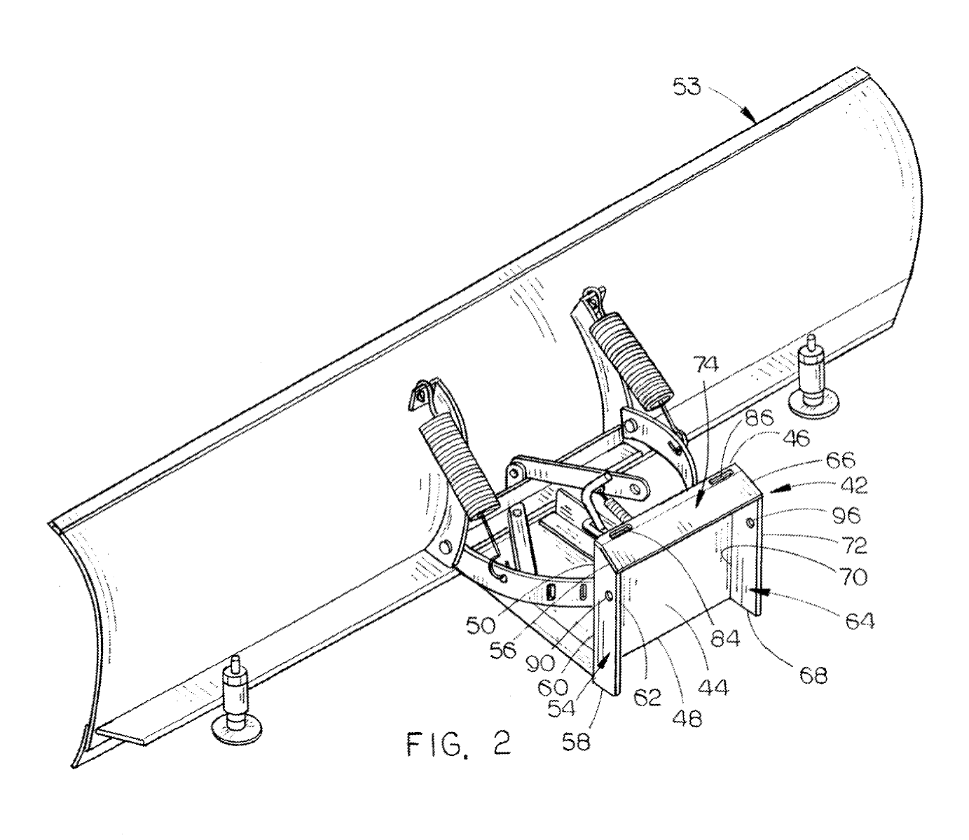

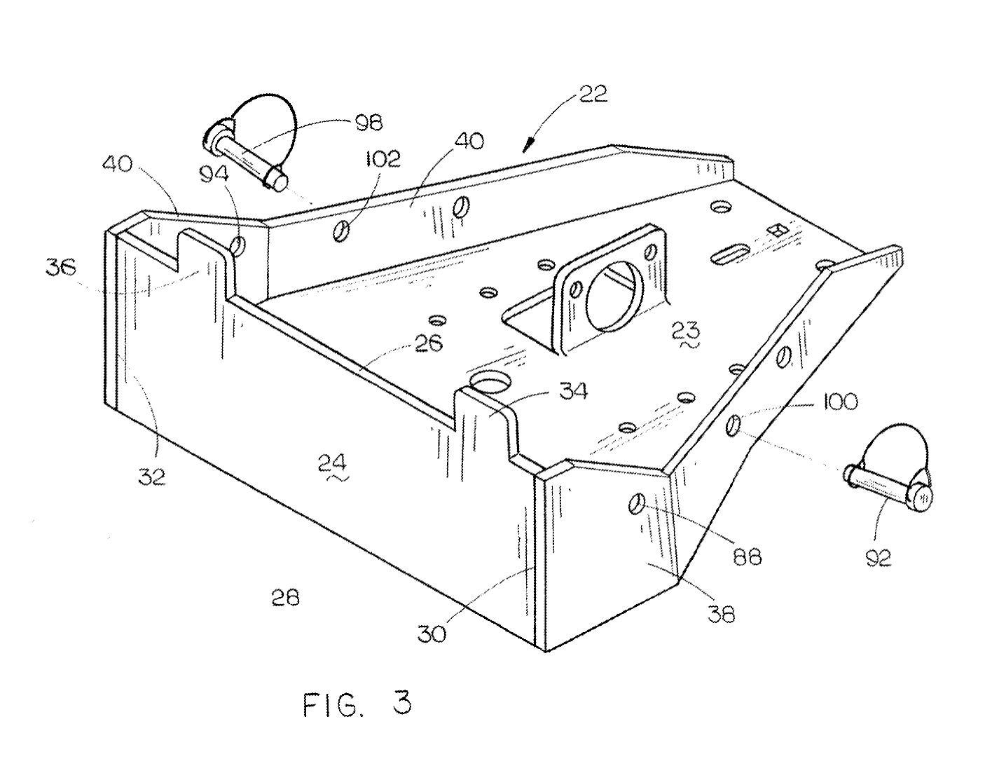

In FIG. 1, the numeral 10 refers to a push tube assembly including push tubes 12 and 14. The rearward ends of push tubes have mounting brackets 16 and 18 secured thereto respectively for attachment to a mount at the underside of the off-road vehicle. The forward end of push tube assembly 10 is raised and lowered by a winch or the like with the winch cable thereof being operatively secured thereto as will be described hereinafter. Plate 20 is selectively removably secured to the forward end of push tubes 12 and 14 by bolts. Rear male quick-attach assembly 22, is secured to plate 20 by bolts B or the like. Assembly 22 includes a base plate 23, an upstanding front wall 24 having an upper end 26, a lower end 28, a first side 30 and a second side 32. A pair of horizontally spaced-apart ears or plates 34 and 36 are secured to the upper end 26 of front wall 24. Although ears 34 and 36 are preferably plate or bar shaped, they could possibly have other shapes. Preferably, assembly 22 also includes side walls 38 and 40 which extend rearwardly from sides 30 and 32 of front wall 24 respectively. The forward ends of side walls 38 and 40 are welded to front wall 24 with the rearward ends thereof being welded to the base plate 23. Side walls 38 and 40 could be integrally formed with base plate 23. Although the rear male quick-attach assembly 22 is shown as being selectively removably secured to the forward end of the push tube assembly 10, the assembly 22 could be factory installed or secured to the push tube assembly 10 by welding or the like.

The numeral 42 refers to the front female quick-attach assembly of this invention. Assembly 42 includes an upstanding front wall 44 which has an upper end 46, a lower end 48, a first side 50 and a second side 52. The lower end of front wall 44 is secured to the implement 53 by welding or the like. Implement 53 may be a blade, sweeper, trash container shuttle, a hitch ball, a hitch receiver tube, etc. Front wall 44 could also be selectively removably secured to the implement by bolts or the like. The numeral 54 refers to a first upstanding side wall 54 having a tapered upper end 56, a lower end 58, a forward end 60 and a rearward end 62. The forward end 60 of side wall 54 is welded to side 50 of front wall 44 with the side wall 54 extending rearwardly from front wall 44.

The numeral 64 refers to a second upstanding side wall having a tapered upper end 66, a lower end 68, a forward end 70 and a rearward end 72. The forward end 70 of side wall 64 is welded to side 52 of front wall 44 with the side wall 64 extending rearwardly from front wall 44. Assembly 42 also includes a top wall 74 having a forward end 76, rearward end 78, first side 80 and second side 82. The forward end 76 of top wall 74 is welded to the upper end 46 of front wall 44. Side 80 of top wall 74 is welded to the tapered upper end 56 of side wall 54. Side 82 of top wall 74 is welded to the tapered upper end 66 of side wall 64. As seen, top wall 74 extends rearwardly and downwardly from front wall 44.

Top wall 74 has a pair of horizontally spaced-apart slot-like openings 84 and 86 formed therein adjacent its forward end which are complimentary in shape to the ears 34 and 36 so as to be able to receive the same, as will be described hereinafter.

Although the front female quick-attach assembly 42 is shown as being selectively removably secured to an implement 53, the assembly 42 could be factory installed or secured to the implement 53 by welding or the like.

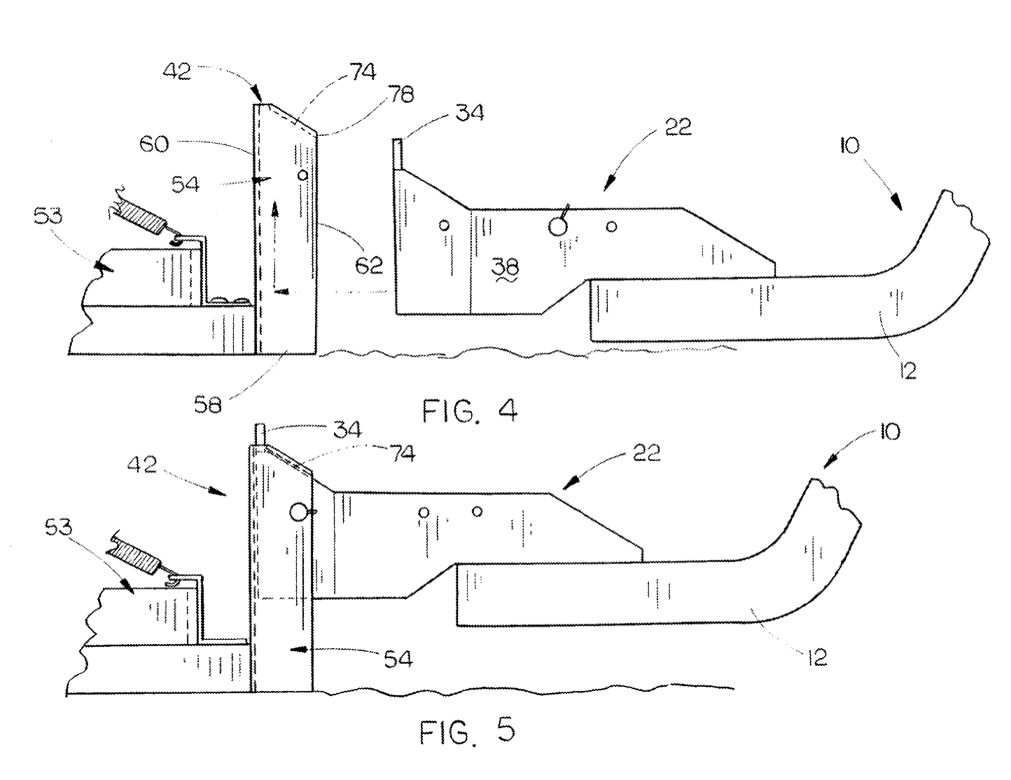

Assuming that the implement 53 is disconnected from the off-road vehicle and is resting on the ground, as seen in FIG. 4, the push tube assembly 10 of the vehicle is connected to the implement as follows. The vehicle is driven forwardly so that the quick-attach assembly 22 is aligned with the front female quick-attach assembly 42. The winch cable or screw actuator attached to the push tube assembly 10 is operated so that the lower end of quick-attach assembly 22 is positioned very close to the ground (FIG. 4). In that position, the upper end of the ears 34 and 36 will be positioned in a plane which is below the rearward end 78 of top wall 74 of quick-attach assembly 42. The vehicle is then driven forwardly so that the front wall 24 of assembly 22 passes between the side walls 54 and 64 of assembly 42 with the ears 34 and 36 passing beneath the rearward end 78 of top wall 74 of assembly 42. As the vehicle is being driven forwardly, the push tube assembly 10 is raised somewhat so that the upper ends of the ears 34 and 36 engage the underside of top wall 74 with the inclined top wall 74 guiding the ears 34 and 36 into alignment with the slots 84 and 86 respectively as the push tube assembly 10 is raised somewhat. When the ears 34 and 36 register with the slots 84 and 86 respectively, the push tube assembly 10 is raised so that the ears 34 and 36 are extended upwardly through the slots 84 and 86 respectively. At that time, the front wall 24 of assembly 22 will be in abutting engagement with front wall 44 of assembly 42. It can be seen that the inclined top wall 74 acts as a guide to position the ears 34 and 36 in slots 84 and 86 respectively.

The assemblies 22 and 42 are then secured together by any suitable locking means. For example, side wall 38 of assembly 22 may have a pin opening 88 formed therein which registers with a pin opening 90 formed in side wall 54 of assembly 42 so that a locking pin 92 may be inserted therethrough. Side wall 40 of assembly 22 and side wall 64 of assembly 42 may also have registering pin openings 94 and 96 formed therein respectively through which a locking pin 98 may be extended. When the assembly 22 is disconnected from assembly 42, pins 92 and 98 may be stowed in openings 100 and 102 formed in side walls 38 and 40 respectively.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

I claim:

1. In combination with an off-road vehicle having forward and rearward ends:
a push tube assembly having rearward and forward ends;
said rearward end of said push tube assembly being secured to the off-road vehicle so that the forward end of said push tube assembly is positioned at the forward end of the vehicle;
a rear male quick-attach assembly, having a forward end and a rearward end, secured to the forward end of said push tube assembly;
a front female quick-attach assembly having a forward end and a rearward end;
said front female quick-attach assembly adapted to have an implement secured thereto;
said rear male and front female quick-attach assemblies being adapted to be secured together;
said rear male quick-attach assembly including an upstanding front wall having an upper end, a lower end, a first side, a second side, a front side and a rear side;
said front wall of said rear male quick-attach assembly having first and second horizontally spaced-apart ears which extend upwardly from said upper end thereof;
said front female quick-attach assembly comprising:
(a) an upstanding front wall having an upper end, a lower end, a first side, a second side, a front side and a rear side;
(b) an upstanding first side wall having an upper end, a lower end, a front end and a rear end;
(c) said first side wall being secured to said first side of said front wall of said front female quick-attach assembly and extends rearwardly therefrom;
(d) an upstanding second side wall having an upper end, a lower end, a front end and a rear end;
(e) said second side wall being secured to said second side of said front wall of said front female quick-attach assembly and extends rearwardly therefrom;
(f) a top wall having a front end, a rear end, a first end and a second end;
(g) said top wall being secured at its said front end to said upper end of said front wall of said front female quick-attach assembly and extends rearwardly therefrom;
(h) said top wall being secured to said upper ends of said first and second side wall of said front female quick-attach assembly and extends therebetween;
(i) said top wall having first and second openings formed therein adjacent said front end thereof adapted to receive said first and second ears of said rear male quick-attach assembly therein respectively when said rear male and front female quick-attach assemblies are secured together;
the distance between said first and second side walls of said front female quick-attach assembly being greater than the distance between said first and second sides of said front wall of said rear male quick-attach assembly so that said front wall of rear male quick-attach assembly may pass forwardly between said first and second side walls to enable said front wall of said rear male quick-attach assembly to be positioned adjacent said front wall of said front female quick-attach assembly;
the distance between said lower end of said front wall of said rear male quick-attach assembly and the upper ends of said first and second ears being less than the distance between said lower ends of said first and second side walls and said rear end of said top wall of said front female quick-attach assembly to enable said rear male quick-attach assembly to move forwardly into said front female quick-attach assembly in a substantially horizontal manner; and
at least one locking device for selectively interconnecting said front female and rear male quick-attach assemblies together.

2. The combination of claim 1 wherein said top wall of said front female quick-attach assembly extends rearwardly and downwardly from said front wall thereof.

3. The combination of claim 1 wherein said first and second openings in said top wall of said front female quick-attach assembly are slot-shaped and wherein said first and second ears are flat bars.

4. The combination of claim 1 wherein said rear male quick-attach assembly is selectively removably secured to said push tube assembly.

5. The combination of claim 4 wherein said rear male quick-attach assembly is selectively removably secured to said push tube assembly by bolts.

6. The combination of claim 1 wherein said front female quick-attach assembly is selectively removably secured to the implement.

7. In combination with an off-road vehicle having forward and rearward ends:
a push tube assembly having rearward and forward ends;
said rearward end of said push tube assembly being secured to the off-road vehicle so that the forward end of said push tube assembly is positioned at the forward end of the vehicle;
a rear male quick-attach assembly, having a forward end and a rearward end, mounted on the forward end of said push tube assembly;
a front female quick-attach assembly having a forward end and a rearward end;
said front female quick-attach assembly adapted to have an implement secured thereto;
said rear male and front female quick-attach assemblies being adapted to be secured together;
at least one locking device for selectively interconnecting said front female and rear male quick assemblies together.

8. The combination of claim 7 wherein said rear male quick-attach assembly is selectively removably secured to said push tube assembly by bolts.

9. The combination of claim 7 wherein said front female quick-attach assembly is selectively removably secured to the implement.

10. The combination of claim 7 wherein said rear male quick-attach assembly is an integral part of said push tube assembly.

11. The combination of claim 10 wherein said rear male quick-attach assembly is welded to said push tube assembly.

12. The combination of claim 1 wherein said front female quick-attach assembly is factory installed on the implement.

13. The combination of claim 7 wherein said implement comprises a blade.

14. The combination of claim 7 wherein said implement comprises a sweeper.

15. The combination of claim 7 wherein said implement comprises a trash container shuttle.

16. The combination of claim 7 wherein said implement comprises a hitch ball structure.

17. The combination of claim 7 wherein said implement comprise a hitch receiver tube.
